(19) United States
(12) Patent Application Publication
(10) Pub. No.: US 2025/0131316 A1
(43) Pub. Date: Apr. 24, 2025

(54) OPERATION OF A QUANTUM COMPUTING ELEMENT

(71) Applicant: RHEINISCH-WESTFALISCHE TECHNISCHE HOCHSCHULE (RWTH) AACHEN, Aachen (DE)

(72) Inventors: MATTHIAS KÜNNE, Aachen (DE); PASCAL CERFONTAINE, Aachen (DE)

(21) Appl. No.: 18/722,203

(22) PCT Filed: Dec. 21, 2021
(86) PCT No.: PCT/EP2021/087075

§ 371 Date: Jun. 20, 2024

(51) Int. Cl. G06N 10/70; G06N 10/40

(52) U.S. Cl. CPC G06N 10/70; G06N 10/40

(57) ABSTRACT

Method for operating a quantum computing element (1) with a network (2) of shuttling lanes (4) having multiple junctions (5) and multiple manipulation zones (7), wherein the method respectively comprises for a plurality of spin qubits (9):
a) initializing the qubit (9),
b) manipulating the qubit (9) in at least one of the manipulation zones (7),
c) reading out the qubit (9),
   wherein at least one of the qubits (9) is shuttled along the network (2) of the shuttling lanes (4) between steps a) and c) so as to pass at least four different of the junctions (5).

### CROSS-REFERENCE TO RELATED APPLICATIONS

The present application is a US National Stage of International Application No. PCT/EP2021/087075 filed on Dec. 21, 2021, which is hereby incorporated by reference in its entirety.

### BACKGROUND OF THE INVENTION

### Field of the Invention

The invention is directed to a method for operating a quantum computing element, to a quantum computer configured to be operated according to this method and to a method for error correction using a quantum computing element.

### Brief Description of the Related Art

It is known that in theory, quantum computers can outperform conventional computers significantly in specific applications. However, quantum computers existing today have limited capabilities. In particular, there is a desire to develop a universal quantum computer. With prior art quantum computing concepts, however, a useful universal quantum computer would require at least 10⁴ logical qubits with error correction. Today, this appears to be difficult or even impossible to achieve.

From WO 2021/052541 A1 a quantum computing device is known that has a network of shuttling lanes. The elements used therein are further described in WO 2021/052531 A1 (shuttling lanes), WO 2021/052539 A1 (junctions), WO 2021/052538 A1 (loading terminals), WO 2021/052537 A1 (manipulation zones) and WO 2021/052536 A1 (readout terminals). Although the quantum computing device described in these documents is already promising, there is still room for improvement, in particular with respect to achieving universal quantum computing.

A major challenge in quantum computing is that qubits are unstable due to decoherence. Attempts have been made to compensate for this, in particular by introducing various error correction measures. For example, in A. G. Fowler, M. Mariantoni, J. M. Martinis, and A. N. Cleland, Phys. Rev. A 86, 032324 (2012) a method for error correction is described. In the following, this will be referred to as “Fowler et al.”. Therein, “ancillary qubits” are used to correct errors in “data qubits”. However, a universal quantum computer implementing this concept would require a significantly large number of data and ancillary qubits.

### SUMMARY OF THE INVENTION

The object of the invention is to provide a quantum computing concept that is more flexible than prior art solutions. As a particular application, it is an object of the invention to provide a respective method for error correction.

The object is solved with the methods and the quantum computer according to the independent claims. Advantageous refinements are presented in the dependent claims. The features described in the claims and in the description can be combined with each other in any technologically reasonable manner.

According to the invention a method is provided for operating a quantum computing element with a network of shuttling lanes having multiple junctions and multiple manipulation zones, wherein the method respectively comprises for a plurality of spin qubits:
a) initializing the qubit,
b) manipulating the qubit in at least one of the manipulation zones,
c) reading out the qubit,

wherein at least one of the qubits is shuttled along the network of the shuttling lanes between steps a) and c) so as to pass at least four different of the junctions.

The method is configured for operating the quantum computing element. In particular, this can be realized in that a quantum algorithm is performed using the quantum computing element. However, the method can also be used to perform only some quantum operations that might not qualify as a complete quantum algorithm. In particular, it is possible to perform only part of a quantum algorithm with the quantum computing element and further parts with different quantum computing hardware. Hence, the method is generally directed to operating the quantum computing element.

The quantum computing element is a piece of hardware. The quantum computing element can be a quantum computer or part of a quantum computer. The quantum computing element can be connected to further quantum computing hardware and/or to further conventional hardware. The quantum computing element can be configured for universal quantum computing. That is, the quantum computing element can be used for various algorithms. Even if the quantum computing element is not configured for what could qualify as universal quantum computing, the described method still allows to use the quantum computing element more flexibly than prior art concepts.

The quantum computing element uses spin qubits. A spin qubit is a two-level quantum system. Preferably, the spin qubits are realized as electron spin qubits or hole spin qubits. An electron spin qubit can be realized with an electron. However, it is also conceivable to realize an electron spin qubit with a group of electrons, for example two or three electrons. In fact, the method can be performed using any conceivable type of spin qubit. An electron can be used as a qubit if the electron spin has been brought into a known state. To this end, an electron can become the realization of a spin qubit by initialization. Usually, a certain qubit remains realized with the same electron throughout an entire quantum algorithm. However, it is also possible that a certain qubit is initialized using a first electron and, after an operation, is realized by means of a second electron. There are even operations after which it is impossible to tell if the qubit is still realized by the first electron or by a different second electron. For performing quantum algorithms this is not a problem since it is sufficient to have the qubit realized in some way at any time. What has been said in this paragraph with respect to electrons applies mutatis mutandis to holes. That is, the method can be performed using any conceivable type of hole spin qubit.

The quantum computing element is preferably based on semiconductor technology. That is, the quantum computing element is preferably made with a semiconductor material, particularly preferably with silicon (Si). Preferably, the semiconductor material is silicon germanium (SiGe), in particular undoped silicon germanium. Besides the semiconductor material, the quantum computing element can comprise further materials, in particular metallic contacts. The quantum computing element can be described as a semiconductor heterostructure. Preferably, the quantum computing element comprises a semiconductor substrate, preferably a SiGe substrate or Si substrate. The substrate is preferably undoped. Using semiconductor materials has the advantage that these materials are comparatively easy to handle and inexpensive. This applies in particular to silicon. On top of that, there are well-established techniques for using silicon in computing hardware. Within the substrate a two-dimensional electron gas (2DEG) or a two-dimensional hole gas (2DHG) can be confined. Using gate electrodes, the electrical potential can be manipulated such as to obtain quantum wells or even quantum dots within the 2DEG or 2DHG. Therein, electrons or holes, respectively, can be trapped so that their spin can be used as a realization of a spin qubit. Moving the electrical potentials can move the quantum wells and quantum dots, which can cause a movement of the charge carrier and, hence, of the qubit.

The quantum computing element has shuttling lanes. The spin qubits can be shuttled, that is moved, along the shuttling lanes. This is supposed to be understood such that, for example, the electron or hole realizing the respective spin qubit is shuttled along the shuttling lane. A shuttling lane is a path configured to actively move the spin qubit. In particular, a shuttling lane can be realized using multiple gate electrodes. By varying the electrical potentials of the gates, the electron or hole can be moved. If the electrical potentials of the gates along the shuttling lane are changed in a successive manner, the electron or hole can thus be moved along the shuttling lane. Preferably, the shuttling lanes are arranged on a surface of the substrate of the quantum computing element. The shuttling lanes are preferably straight. That is, the electrons or holes moving along the shuttling lanes do not have to follow a winding or curved path, which would be more difficult to achieve.

The network of the shuttling lanes comprises multiple junctions. The junctions are preferably T-junctions. That is, an end of a first shuttling lane is connected to a second shuttling lane at a point spaced apart from the ends of the second shuttling lane. Also, X-junctions are conceivable. Therein, two shuttling lanes meet at a point that is spaced apart from the ends of both shuttling lanes. For practical reasons it can be easier to realize an X-junction by a pair T-junctions. An X-junction is considered to be realized by a pair of T-junctions unless two shuttling lanes cross each other so that both form straight lines at least in the proximity of the X-junction. If, however, one of the two crossing shuttling lanes is offset at the junction, the junction is considered to be realized by a pair of T-junctions.

Further, the quantum computing element comprises manipulation zones. Within a manipulation zone, the state of the spin qubit can be changed. Thereby, quantum operations can be performed. In a manipulation zone a single qubit can be manipulated. The respective operation can be referred to as a single-qubit operation. Also, multiple qubits can be manipulated together in the same manipulation zone. In particular, this can be done with two qubits. The respective operation can be referred to as a multi-qubit operation, in particular as a two-qubit operation.

The method comprises, for a plurality of qubits, steps a) to c). That is, for each of the qubits steps a) to c) are respectively performed. For each of the qubits, the respective steps a) to c) are preferably performed in the stated order.

During steps a) to c) the spin qubit is supposed to remain stable. That is, the qubit state is not supposed to be changed unintentionally or in an arbitrary manner. However, in particular due to decoherence it is possible for spin qubits to lose their state. This unavoidable effect leads to errors that can be dealt with by error correction. Also, decoherence losses can be minimized in that the spin qubits are shuttled distances as short as possible. The coherence time of spin qubits realized in semiconductors depends on the temperature. It is therefore preferred to perform the method with the quantum computing element being placed in a refrigerator at a temperature of less than 4 K, preferably of less than 1 K. In experiments, particularly good results were achieved at 30 mK.

In the following, steps a) to c) are described for one of the qubits. Exemplarily, an electron spin qubit is considered. In step a) the qubit is initialized. This can be realized in that the respective electron is loaded into the network of the shuttling lanes in such a way that the spin state of the electron is known. The spin state can thus be used as the qubit realization. Preferably, the quantum computing element comprises at least one loading terminal. With the loading terminal, an electron can be loaded into the network of the shuttling lanes. In case the quantum computing element comprises several loading terminals, each of the qubits can be loaded using one of the loading terminals. It is possible to load several qubits one after the other using the same loading terminal. Alternatively, the qubit can be loaded into the network of the shuttling lanes in that the qubit is moved from outside the network of the shuttling lanes into the network of the shuttling lanes. This is possible in particular in case the quantum computing element is connected to further quantum computing hardware that is not considered part of the quantum computing element. It is, however, not necessary that the initialization according to step a) is performed in that the qubit is loaded into the network of the shuttling lanes. Alternatively, the qubit can be initialized in step a) in that an electron that is already present within the network of the shuttling lanes is manipulated such that its spin state becomes known. For example, an electron can be used that has been loaded into the network of the shuttling lanes for a previous performance of a quantum algorithm. An electron already present within the network of the shuttling lanes can be initialized in any way that results in knowledge of the spin state of the electron. For example, a qubit can be read out at the end of a previous quantum algorithm. As a result of the readout, the qubit can be in a known state. To this end, the qubit can be used for the following quantum algorithm. That is, a readout step of a first quantum algorithm can be an initialization step for a following quantum algorithm. Also, it is possible to relax the spin qubits into their ground state by waiting a sufficient time. This is the simplest, but also a rather slow way of initializing a qubit.

In step b) the qubit is manipulated in at least one of the manipulation zones. Therein, a single-qubit operation or a multi-qubit operation, in particular a two-qubit operation is possible. A single-qubit operation can be, in particular, a spin-flip. A two-qubit operation can be, in particular, an entanglement of the two qubits. In case of a multi-qubit operation, the involved qubits are jointly manipulated within the respective manipulation zone. To this end, step b) can be performed jointly for multiple qubits. With manipulating the qubits in the manipulation zones, a quantum algorithm can be realized. Therein, the quantum algorithm determines how many qubits are involved and which qubit is manipulated when, in which manipulation zone and by means of which operation. Since the described quantum computing element is preferably configured for universal quantum computing, generally all potential combinations of manipulation operations are conceivable.

In step c) the qubit is read out. That is, the state of the qubit is determined by measurement. Since the qubits are spin qubits, this means that the spin of the qubits is measured. With the measurement the state of the qubit is lost such that the quantum operation is terminated by the measurement. The result of the respective step c) for each of the involved qubits can be further processed using conventional computer hardware.

Step a) is preferably performed using a loading terminal. Step c) is preferably performed using a readout terminal. It is possible that a loading terminal and a readout terminal are realized using the same element, which could be referred to as a loading and readout terminal. In such a case steps a) and c) can be performed using a loading and readout terminal.

In between steps a) to c) the qubit can be shuttled along one or more of the shuttling lanes. For example, the qubit can be loaded into the shuttling lane using a loading terminal (step a)), be shuttled from the loading terminal to a manipulation zone, where it is manipulated (step b)), be shuttled from the manipulation zone to a readout terminal, where it is read out (step c)). In step b) the qubit can also be shuttled from the manipulation zone to a further manipulation zone, where it is manipulated a second time. This can be repeated with even further manipulation zones.

The network of the shuttling lanes is preferably configured with a pattern that repeats itself. Preferably, the network of the shuttling lanes is configured as a grid. Adjacent rows of the grid are preferably offset from each other such that the grid involves only T-junctions rather than X-junctions, which would be more difficult to realize. However, it is not necessary that the network cells have a rectangular shape. It is also possible to have network cells, for example, having a hexagonal shape.

In case the network of the shuttling lanes is configured with a pattern that repeats itself, a unitary cell can be identified. The network can comprise multiple copies of the unitary cell arranged next to each other in rows and columns. This way, the two-dimensional network of the shuttling lanes can be obtained. At its edges, the network can deviate from the described structure based on the unitary cell. That is, at its edges the network might have incomplete copies of the unitary cell or merely shuttling lanes that are not part of a copy of the unitary cell.

Preferably, the unitary cell is defined merely with respect to the shuttling lanes. That is, each copy of the unitary cell has the same arrangement of the shuttling lanes. This includes that each copy of the unitary cell has the same number and arrangement of junctions. However, elements such as loading terminals, manipulation zones and readout terminals can be arranged independently of a definition of a unitary cell. That is, these copies of the unitary cell can differ in the number and arrangement of these elements. Nevertheless, it is preferred that each copy of the unitary cell has the same number and arrangement of loading terminal(s), manipulation zone(s) and readout terminal(s). That is, the copies of the unitary cell are identical to each other not only with respect to the arrangement of the shuttling lanes, but also with respect to further elements. Preferably, each copy of the unitary cell has exactly one loading terminal, exactly one manipulation zone and exactly one readout terminal.

It is preferred that not each copy of the unitary cell has a respective loading terminal. It would even be sufficient for the network to have only a single loading terminal. A small number of loading terminals can facilitate manufacture. Also, having the loading terminal(s) spaced apart from the qubits during operation can improve the performance. Providing more loading terminals, however, can increase the loading efficiency and reduce the distances the qubits have to be shuttled. In view of this it was found to be reasonable for the network to have one loading terminal per 5 to 20 of the junctions. This is a reasonable definition since the number of the junctions is a measure for the number of the copies of the unitary cell. The junctions can be, in particular, T-junctions or X-junctions. A T-junction counts as one junction and an X-junction counts as one junction. However, if an X-junction is realized by a pair of T-junctions, such an X-junction counts as two junctions. However, it would also be conceivable that each copy of the unitary cell comprises a respective loading terminal. In any case, it is sufficient if each copy of the unitary cell has at most one loading terminal.

Also, it is preferred that not each copy of the unitary cell has a respective readout terminal. It would even be sufficient for the network to have a single readout terminal. A small number of readout terminals can facilitate manufacture. Also, having the readout terminal(s) spaced apart from the qubits during operation can improve the performance. Providing more readout terminals, however, can increase the readout efficiency and reduce the distances the qubits have to be shuttled. In view of this it was found to be reasonable for the network to have one readout terminal per 5 to 20 of the junctions.

It is particularly preferred to have as few loading terminals and as few readout

terminals as possible. This is due to the fact that both the loading terminals and the readout terminals can cause heat intake into the quantum computing element, which could reduce the coherence time of the qubits. Ideally, the quantum computing element has only one loading and readout terminal that is used for both loading and readout of all qubits. However, it is already advantageous if the sum of the number of loading terminals, the number of the readout terminals and the number of loading and readout terminals is smaller than the number of network cells, in particular by a factor of at least 10, more particularly even by a factor of at least 100. Since the number of the junctions is a measure for the number of the network cells, it is preferred that the sum of the number of loading terminals, the number of the readout terminals and the number of loading and readout terminals is smaller than the number of the junctions, in particular by a factor of at least 10, more particularly even by a factor of at least 100.

It is conceivable that the number of loading terminals is equal to the number of readout terminals. For example, a ratio between the number of loading terminals and the number of readout terminals can be in the range of 0.5 to 2. However, it would also be conceivable that each copy of the unitary cell comprises a respective readout terminal. In any case, it is sufficient if each copy of the unitary cell has at most one readout terminal.

It is further preferred that each copy of the unitary cell has a respective manipulation zone.

The concept of the unitary cell cannot only be used in order to describe the arrangement of the shuttling lanes and the elements connected therewith. The number of copies of the unitary cell can also be brought in relation with the number of qubits that are used in the method. It would be possible to use one qubit per copy of the unitary cell. In that case, each qubit would have its own copy of the unitary cell and each of the unitary cells would have one and only one qubit. In a particularly simple case each qubit would be loaded into a shuttling lane of its copy of the unitary cell using the loading terminal of this copy of the unitary cell, shuttled to the manipulation zone of this copy of the unitary cell, manipulated therein, shuttled to the readout terminal of this copy of the unitary cell and read out therein. To this end, the qubit would not have to leave its copy of the unitary cell. Since this could apply to all qubits, there would be no interference between qubits since none of the qubits would enter the copy of the unitary cell assigned to a different qubit.

However, it was found that there is no need for such a restriction in the number of qubits and in where the qubits can be shuttled. In fact, it was found that there is not even a need to assign qubits to copies of a unitary cell, or vice versa. Hence, the described method can involve any number of qubits independently of the extent of the network of the shuttling lanes, in particular independently of the number of copies of a unitary cell. Also, the qubits can move freely through the entire network of the shuttling lanes, where only decoherence losses might limit the distance the qubits can be shuttled. That is, it is preferred that between steps a) to c) at least one of the qubits is moved through multiple copies of a unitary cell. This definition naturally applies only in case a unitary cell can be identified. However, the concept can also be transferred to an arbitrary network of shuttling lanes. Even in that case the insight can be used that the number of qubits and the area in which they can be moved can be chosen independently of the configuration of the network of the shuttling lanes. According to a generally applicable definition of this insight, at least one of the qubits is shuttled along the network of the shuttling lanes between steps a) and c) so as to pass at least four different of the junctions. It was found that this is the key idea of the described concept. The junctions can be, in particular, T-junctions or X-junctions. Passing a T-junction counts as one junction and passing an X-junction counts as one junction. However, if an X-junction is realized by a pair of T-junctions, passing such an X-junction counts as passing two junctions. Up to a certain point, the described advantage will generally be the more pronounced, the more junctions are passed. The optimal number of junctions passed can depend on details of the quantum algorithm and/or on the coherence time. Hence, it is preferred that at least one of the qubits is shuttled along the network of the shuttling lanes between steps a) and c) so as to pass at least five, in particular at least ten different of the junctions. It is particularly preferred that at least one of the qubits is shuttled along the network of the shuttling lanes between steps a) and c) so as to pass between four and ten different of the junctions. The more qubits fulfil the requirement regarding the number of passed junctions, the more pronounced will the described advantage generally be. Hence, it is preferred that at least half the qubits are respectively shuttled along the network of the shuttling lanes between the respective steps a) and c) so as to pass at least four different of the junctions, in particular at least five, in particular at least ten different of the junctions, in particular between four and ten different of the junctions. It is also possible that all qubits fulfill this requirement.

Passing at least four different of the junctions between steps a) and c) can be achieved in various ways. In a first example, a qubit is initialized in step a) by loading a charge carrier into the network such as to have a known spin state. This can be done using a loading terminal. The loading terminal can be arranged at the end of a dead-end shuttling lane that branches off from another shuttling lane. To this end, the qubit can pass the first junction immediately after being moved out of the loading terminal. In step c) the qubit can be read out using a readout terminal. The readout terminal can be arranged at the end of a dead-end shuttling lane that branches off from another shuttling lane. To this end, the qubit can pass another junction immediately before being moved into the readout terminal. That is, in the first example the qubit can pass at least four different junctions between steps a) and c) in that it passes at least two different junctions other than the two junctions assigned to the loading terminal and the readout terminal.

In a second example, all qubits are initialized in step a) by loading a respective charge carrier into the network such as to have a known spin state. Therein, for all qubits the same loading terminal arranged at the edge of the network is used. After having been loaded, the qubits are shuttled to the location in the network where they are supposed to be used. Since the loading terminal is arranged at the edge of the network, this generally involves passing a plurality of the junctions. In variants of the second example, there is more than one loading terminal and/or the loading terminal(s) is/are not arranged at the edge of the network. Therein, it is still possible to have at least one of the qubits being shuttled along the network of the shuttling lanes between steps a) and c) so as to pass at least four different of the junctions.

In a third example an electron already present in the network of the shuttling lanes is used for initializing a qubit in step a). That is, this qubit is not initialized by loading a charge carrier into the network. This qubit can be shuttled along the network of the shuttling lanes between steps a) and c) so as to pass at least four different of the junctions in that none of these four junctions is one assigned to a loading terminal or readout terminal.

The shuttling lanes can be configured as described in the published document WO 2021/052531 A1, which is hereby entirely incorporated by reference as forming part of the invention. The junctions can be configured as described in the published document WO 2021/052539 A1, which is hereby entirely incorporated by reference as forming part of the invention. The loading terminal(s) can be configured as described in the published document WO 2021/052538 A1, which is hereby entirely incorporated by reference as forming part of the invention. The manipulation zones can be configured as described in the published document WO 2021/052537 A1, which is hereby entirely incorporated by reference as forming part of the invention. The readout terminal(s) can be configured as described in the published document WO 2021/052536 A1, which is hereby entirely incorporated by reference as forming part of the invention. The network of the shuttling lanes can be configured as described in the published document WO 2021/052541 A1, which is hereby entirely incorporated by reference as forming part of the invention.

In a preferred embodiment of the method steps a) to c) are performed simultaneously for at least some of the qubits.

Steps a) to c) are preformed respectively for each of the qubits involved in the method. If step b) is realized as a multi-qubit operation, step b) is performed jointly for the corresponding qubits. Apart therefrom can steps a) to c) be performed independently for the individual qubits. To this end it can be chosen comparatively freely for each qubit when the respective steps a) to c) are performed. However, it was found that performing steps a) to c) simultaneously for at least some of the qubits is advantageous not only in view of computation time. More importantly, it was found that decoherence losses can be reduced if the steps a) to c) are performed simultaneously for at least some of the qubits. Ideally, steps a) to c) are performed simultaneously for all qubits.

In a further preferred embodiment, the method comprises multiple adjacent time intervals, and wherein in each of the time intervals steps a) to c) are performed for a respective set of the qubits.

Steps a) to c) can be performed multiple times for one, some or all of the qubits. Therein, dividing the method into the time intervals facilitates interaction between the qubits. At certain points of time, that is at the beginnings and ends of the time intervals, steps a) to c) have been finished for all qubits. Hence, there is no need to wait for a certain qubit in order to begin the next cycle.

In a further preferred embodiment of the method at least temporarily the number of the qubits is higher than half the number of the junctions.

The above-described key concept is to move the qubits freely through the network of the shuttling lanes, that is without any strict assignment between the qubits and network cells. This also means that the number of qubits is not limited with respect to the number of network cells. Since the number of network cells is generally related to the number of the junctions, this means that the number of qubits is not limited with respect to the number of the junctions. In the present embodiment this is expressed in that at least temporarily the number of qubits is higher than half the number of the junctions. Preferably, the at least temporarily the number of qubits is higher than the number of the junctions, in particular higher than twice the number of the junctions. Theoretically, there is no upper limit for the number of the qubits. However, it was found that for practical reasons it is advantageous if the number of the qubits does not exceed twenty times the number of the junctions, in particular if the number of the qubits does not exceed ten times the number of the junctions.

The junctions can be, in particular, T-junctions or X-junctions. A T-junction counts as one junction and an X-junction counts as one junction. However, if an X-junction is realized by a pair of T-junctions, such an X-junction counts as two junctions.

With the number of the qubits being as high as described, it is preferred that at least one of the manipulation zones is configured to perform at least a SWAP operation. That is, the manipulation zone is used as a realization of a SWAP gate, and potentially of one or more further gates. In that case it is possible to have qubits arranged in a group, wherein the qubits of a group are shuttled through the shuttling lanes together. Therein, the qubits of a group can form a line within the shuttling lanes, such that the qubits of the group are arranged one after the other. Since the shuttling lanes can be considered to be one-dimensional, the qubits of a group will generally have a fixed order. However, by means of a SWAP operation, the order of the qubits within a certain group can be changed. To this end it is possible, for example, to entangle two qubits of a group with each other, even if these qubits are initially not arranged next to each other. It is particularly preferred that the entanglement and the SWAP operation are performed using the same manipulation zone. It is even possible to have a group of qubits assigned to a certain manipulation zone, wherein all operations for these qubits are performed using this manipulation zone only. That is, the group of qubits can be shuttled through the manipulation zone back and forth, wherein the qubits switch places whenever necessary. In theory, an entire quantum algorithm can thus be performed using a group of qubits and a single manipulation zone.

Alternatively or additionally, it is preferred that at least temporarily the number of the qubits is higher than the number of the manipulation zones. This is a further way of expressing that with the described method there is no strict assignment between the qubits and network cells.

In a further preferred embodiment of the method at least some of the qubits are shuttled past the at least one manipulation zone in which they are manipulated in step b).

In this embodiment the qubit is moved into the respective manipulation zone from a first side of the manipulation zone, manipulated in the manipulation zone, and moved out of the manipulation zone at a second side of the manipulation zone. To this end, the qubit does not change its shuttling direction for the manipulation.

It is possible for a first qubit to meet a second qubit while the first qubit is shuttled past a manipulation zone. The second qubit can be stationary within the manipulation zone or can be shuttled past the manipulation zone in a direction opposite to the direction of the first qubit. This can be realized in that the manipulation zone is configured to perform at least a SWAP operation. That is, the manipulation zone is used as a realization of a SWAP gate, and potentially of one or more further gates. Therein, it is possible that the charge carrier used for realizing the first qubit before the swap is used for realizing the second qubit after the swap, and vice versa. It is even possible that after the swap it cannot be determined whether or not the first qubit is realized by the same charger carrier before and after the swap and whether or not the second qubit is realized by the same charger carrier before and after the swap. This is acceptable because the qubit, i.e. the representation of a certain quantum state, is supposed to be moved, which is not strictly bond to a certain charge carrier.

In a further preferred embodiment of the method at least some of the qubits have a shuttling direction reversed at the at least one manipulation zone in which they are manipulated in step b).

In this embodiment the qubit is moved into the respective manipulation zone from a first side of the manipulation zone, manipulated in the manipulation zone, and moved out of the manipulation zone at the first side of the manipulation zone. To this end, the qubit has its shuttling direction reversed at the manipulation zone.

Depending on what operations are supposed to be carried out using the described method, in particular depending on which quantum algorithm is supposed to be carried out, it can be chosen which qubits should be shuttled past which of the manipulation zones and which qubits should have their shuttling direction reversed at which of the manipulation zones. Since the described quantum computing element is preferably configured for universal quantum computing, the choice between these options can preferably be made by software rather than by a fixed hardware configuration.

In a further preferred embodiment of the method at least some of the qubits are successively manipulated in multiple of the manipulation zones, and wherein the respective qubits are shuttled in between these manipulation zones.

In this embodiment, for example, the method can respectively comprise for a plurality of spin qubits:
a) initializing the qubit, in particular by loading the qubit into the network of the shuttling lanes using a loading terminal,
   shuttling the qubit to a first manipulation zone, in particular from the loading terminal,
b) manipulating the qubit in the first manipulation zone,
   shuttling the qubit from the first manipulation zone to a second manipulation zone,
   manipulating the qubit in the second manipulation zone,
   shuttling the qubit from the second manipulation zone, in particular to a readout terminal,
c) reading out the qubit, in particular using the readout terminal.

For qubits that are manipulated in three or more manipulation zones in step b), this can easily be extended in that step b) further involves a respective shuttling and manipulation substep.

Manipulating one, some or all of the qubits in more than one of the manipulation zones can increase efficiency. This is due to the fact that it is thereby not necessary to load and read out the qubits before and after each manipulation. Also, this makes it possible to perform multi-operation quantum algorithms.

In a further preferred embodiment of the method for at least some of the qubits the manipulation in the respective step b) is an entanglement with at least one further of the qubits.

Entangling two qubits with each other is an example of a two-qubit operation. Most practically useful quantum algorithms involve entangling of qubits. Entangling is possible if the two involved qubits are both shuttled into the same manipulation zone so that eventually both qubits are in the manipulation zone at the same time. It was found that the described method is particularly suitable for entangling qubits. This is due to the fact that with the described method there is no strict assignment between network cells and qubits. Hence, two qubits can be shuttled from anywhere in the network to meet in a certain manipulation zone for entanglement. To this end the described method is particularly flexible in that any qubits can be entangled with each other. This can contribute to achieving universal quantum computing. Were there a strict assignment between qubits and network cells, at best two qubits from neighboring network cells could be entangled with each other.

In a further preferred embodiment the method is a realization of a surface code.

A surface code is a realization of a quantum algorithm which involves movement of qubits on a surface. An example of a surface code that involves error correction has been described in Fowler et al. Therein, however, the movement of the qubits was restricted compared to the described method.

In general, the method can be a realization of any QEC code, in particular of a 2D code, a 3D code, a color code or a stabilizer code.

As a further aspect of the invention a quantum computer is provided that comprises:
a quantum computing element having a network of shuttling lanes with multiple junctions and multiple manipulation zones,
a control installation connected to the quantum computing element and configured for performing a method according to any of the preceding claims.

The advantages and features of the method are transferrable to the quantum computer, and vice versa. The quantum computer is preferably configured to be used according to the method. The method is preferably performed using the quantum computer.

As a further aspect of the invention a method for error correction using a quantum computing element with a network of shuttling lanes having multiple X-junctions so as to form multiple network cells is presented, wherein the network further has multiple manipulation zones, wherein the method comprises loading a respective data qubit into each of the manipulation zones,

wherein the method comprises for at least some of the X-junctions of the network:
A1) initializing a respective ancillary qubit in one of the shuttling lanes adjacent to the respective junction,
A2) successively shuttling the ancillary qubit to the manipulation zones adjacent to the respective X-junction and entangling the ancillary qubit with the data qubits in these manipulation zones,
A3) reading out the ancillary qubit,
wherein the method subsequently comprises for each of the network cells:
B1) initializing a respective ancillary qubit in one of the shuttling lanes of the respective network cell,
B2) successively shuttling the ancillary qubit to the manipulation zones of the respective network cell and entangling the ancillary qubit with the data qubits in these manipulation zones,
B3) reading out the ancillary qubit,
   wherein the data qubits and the ancillary qubits are spin qubits.

The advantages and features of the previously described method and of the quantum computer are transferrable to the currently described method, and vice versa. Preferably, the quantum computing element used in the method for error correction is configured like the quantum computing element described above with respect to the method for operating a quantum computing element.

The method for error correction involves a network of the shuttling lanes that comprises X-junctions. For practical reasons, the X-junction are preferably realized by a respective pair of T-junctions.

The method for error correction is a particularly preferred example of how the advantages of the above described method for operating a quantum computing element can be exploited. The method for error correction is a refinement of what has been described in Fowler et al. It was found that the above described key concept of qubits that are not assigned to network cells can reduce the number of qubits required for the teaching of Fowler et al. significantly.

In the following it is distinguished between physical qubits, logical qubits, data qubits and ancillary qubits. A physical qubit is realized physically, for example using an electron spin. The state of a physical qubit, however, is usually not as stable as desired for performing quantum algorithms. Hence, “logical qubits” have been established. A logical qubit is stable and thus can be used in a quantum algorithm. A logical qubit can be obtained using multiple physical qubits and error correction methods. In the following, logical qubits are considered that are realized by two physical qubits: a data qubit and an ancillary qubit. In general, the state of the data qubit represents the state of the logical qubit. The ancillary qubit is used for error correction, that is for preventing the state of the data qubit to be lost due to decoherence.

In the method for error correction, the data qubits are initialized in the manipulation zones. Preferably, the data qubits remain in the respective manipulation zone throughout the method. The ancillary qubits, in contrast, are shuttled along the shuttling lanes. To this end, each of the ancillary qubits can interact with several of the data qubits and each of the data qubits can interact with several of the ancillary qubits. Thereby, error correction can be performed. For further details to this end, it is referred to the cited article by Fowler et al.

The key difference between the described method and the teaching of Fowler et al. is the way the ancillary qubits are shuttled. Therein, the finding is exploited that qubits can be shuttled freely, in particular independently of network cells. This is expressed in that the method comprises steps A1) to A3) for at least some of the junctions and steps B1) to B3) for each of the network cells. Both these sets of steps are a realization of steps a) to c) of the above described method for operating a quantum computing element.

In a preferred embodiment of the method steps A1) to A3) are performed alternatingly with steps B1) to B3).

### BRIEF DESCRIPTION OF THE DRAWINGS

In a further preferred embodiment of the method steps A1) to A3) are performed simultaneously for all ancillary qubits and/or wherein steps B1) to B3) are performed simultaneously for all ancillary qubits.

In the following the invention will be described with respect to the figures. The figures show preferred embodiments, to which the invention is not limited. The figures and the dimensions shown therein are only schematic. The figures show:

FIG. 1 is a diagram of a quantum computing element according to the invention,

FIG. 2 is a diagram of a quantum computer according to the invention,

FIG. 3 illustrates a part of a shuttling lane of the quantum computing element of FIG. 1,

FIG. 4 is a cross-section of the shuttling lane of FIG. 3,

FIG. 5 illustrates a T-junction of the quantum computing element of FIG. 1,

FIG. 6 is a cross-section of the T-junction of FIG. 5 with a sequence illustrating the development of the electrical potential within the T-junction,

FIG. 7 illustrates a manipulation zone of the quantum computing element of FIG. 1,

FIG. 8 is a cross-section of the manipulation zone of FIG. 7 with a sequence illustrating the development of the electrical potential within the manipulation zone during a single-qubit operation,

FIG. 9 is a cross-section of the manipulation zone of FIG. 7 with a sequence illustrating the development of the electrical potential within the manipulation zone during a two-qubit operation,

FIG. 10 illustrates a loading terminal of the quantum computing element of FIG. 1,

FIG. 11 is a cross-section of the loading terminal of FIG. 10 with a sequence illustrating the development of the electrical potential within the loading terminal during a loading,

FIG. 12 illustrates a readout terminal of the quantum computing element of FIG. 1,

FIG. 13 is a cross-section of the readout terminal of FIG. 12 with a sequence illustrating the development of the electrical potential within the readout terminal during a readout,

FIG. 14 is an illustration of a prior art method for error correction, and

FIGS. 15 to 18 are illustrations of a method for error correction according to the invention.

### DETAILED DESCRIPTION OF THE INVENTION

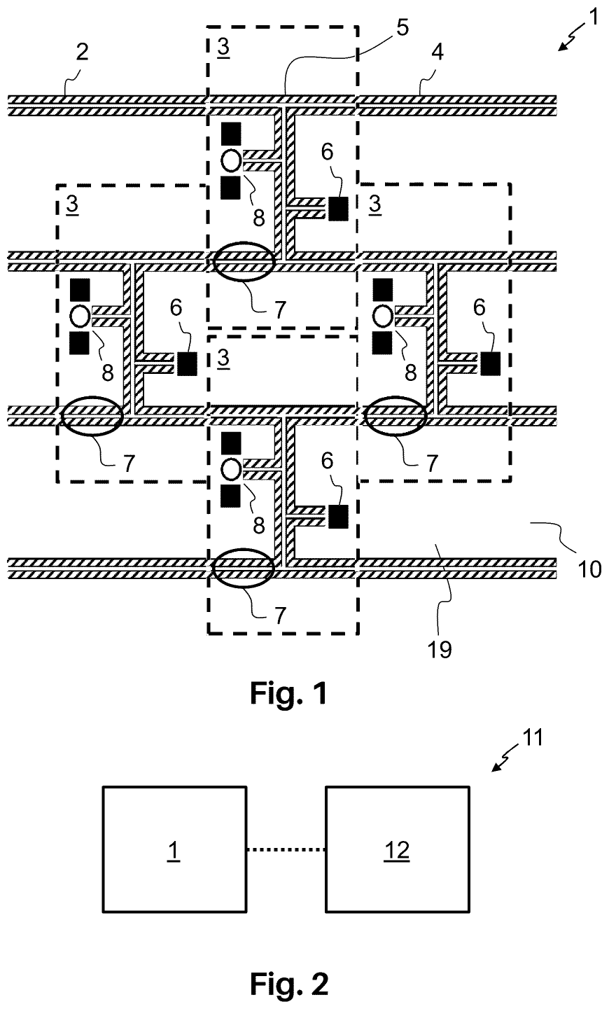

FIG. 1 shows a quantum computing element 1 with a network 2 of shuttling lanes 4 having four network cells 3. The network 2 is realized on a surface 19 of a substrate 10. The network cells 3 have an expansion of the order of 10 μm [micrometers]. The shuttling lanes 4 are connected to each other via junctions 5. Each of the network cells 3 has a respective loading terminal 6, a respective manipulation zone 7 and a respective readout terminal 8. The quantum computing element 1 is configured for a method which respectively comprises for a plurality of spin qubits 9 (which are merely indicated by a reference numeral assigned to the shuttling lanes 4, since the qubits 9 can be anywhere in the shuttling lanes 4):
a) initializing the qubit 9 by loading a respective electron or hole into the network 2 of the shuttling lanes 4 using one of the loading terminals 6,
b) manipulating the qubit 9 in at least one of the manipulation zones 7,
c) reading out the qubit 9 using one of the readout terminals 8,
   wherein at least one of the qubits 9 is shuttled along the network 2 of the shuttling lanes 4 between steps a) and c) so as to pass at least four different of the junctions 5. In particular, these qubits 9 are not bound to one of the network cells 3. Instead, these qubits 9 can be moved across multiple of the network cells 3. Also, at least temporarily the number of qubits 9 can be higher than half the number of the junctions 5. Also, the number of qubits 9 can be higher than the number of the network cells 3.

Steps a) to c) can be performed simultaneously for at least some of the qubits 9. In particular, the method may comprise multiple adjacent time intervals, wherein in each of the time intervals steps a) to c) are performed for a respective set of the qubits 9.

The qubits 9 can be manipulated in the respective manipulation zone(s) 7 in various ways. For example, at least some of the qubits 9 can be shuttled past the respective manipulation zone 7 in which they are manipulated in step b) and/or at least some of the qubits 9 can have a shuttling direction reversed at the respective manipulation zone 7 in which they are manipulated in step b).

Some or all of the qubits 9 can be successively manipulated in multiple of the manipulation zones 7. These qubits 9 are shuttled in between these manipulation zones 7. For at least some of the qubits 9 the manipulation in the respective step b) can be an entanglement with at least one further of the qubits 9.

The method can be a realization of a surface code.

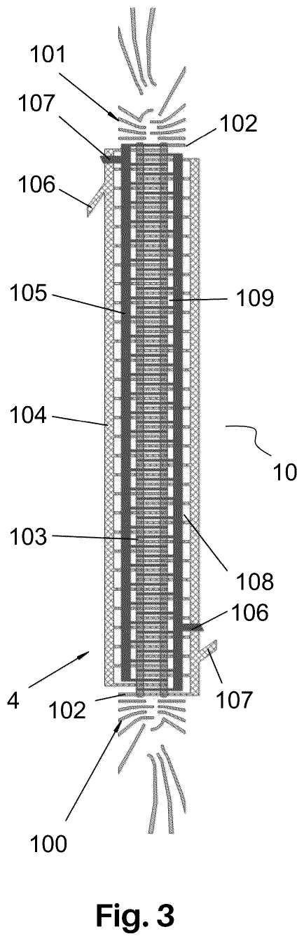

FIG. 2 shows a quantum computer 11 comprising a quantum computing element 1 having a network 2 of shuttling lanes 4 with multiple junctions 5 and multiple manipulation zones 7. The quantum computing element 1 can be configured as shown in FIG. 1. Further, the quantum computer 11 comprises a control installation 12 connected to the quantum computing element 1. The control installation 12 can be configured for performing the method described with respect to FIG. 1.

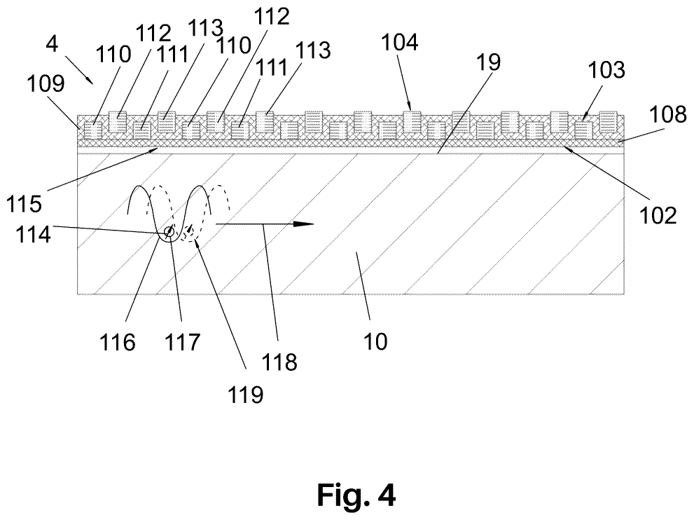

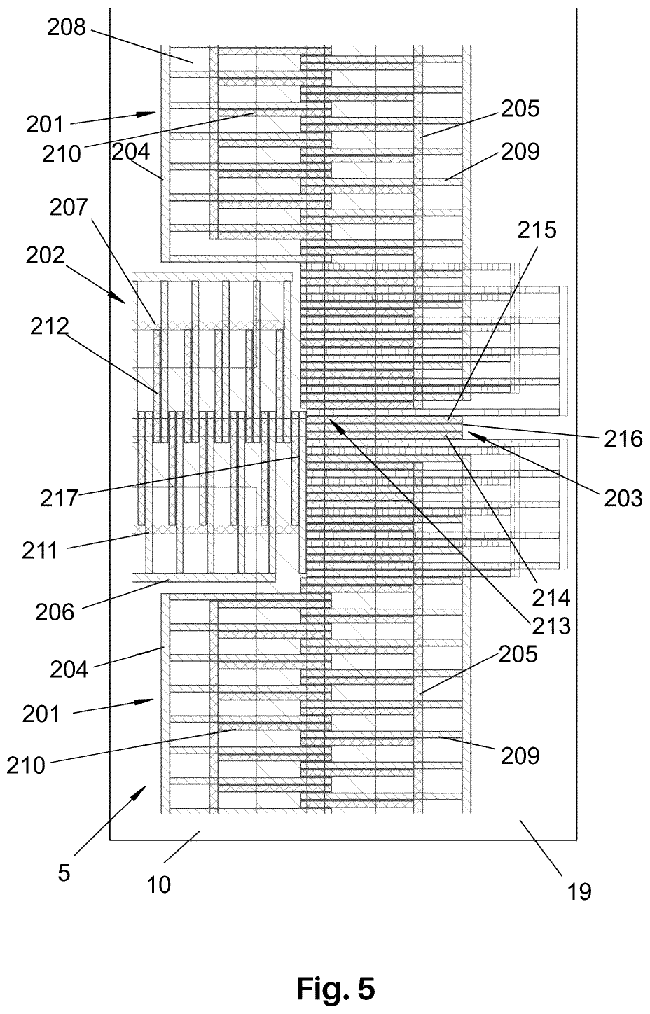

FIGS. 3 and 4 illustrate how the shuttling lanes 4 of the quantum computing element 1 of FIG. 1 can be realized. Therefore, FIG. 3 shows schematically a top view of a part of the semiconductor substrate 10 of the quantum computing element 1 of FIG. 1. The part of the semiconductor substrate 10 shown in FIG. 3 includes one of the shuttling lanes 4 that extends between a first side 100 and a second side 101. Therefore, three layers of gate electrode arrays 102, 103, 104 are provided that are separated from each other by insulating layers 108, 109. A respective electrical voltage can be applied to the gate electrode arrays 102, 103, 104 with one or more voltage source(s) (not shown). Therefore, the gate electrode arrays 102, 103, 104 have respective electrical terminals 105, 106, 107.

The first gate electrode array 102 rests on the surface 19 of the substrate 10. The first gate electrode array 102 is followed by the insulating layer 108, on which the second gate electrode array 103 is provided. On top of the second gate electrode array 103 is arranged the insulating layer 109, which electrically isolates the second gate electrode array 103 from the third and uppermost gate electrode array 104.

FIG. 4 shows a cross-section of the part of the substrate 10 shown in FIG. 3. Therein, gate electrodes 115 of the first gate electrode array 102 can be seen. The gate electrode 115 extends longitudinally on the surface 19 of the substrate 10 and is separated from the second gate electrode array 103 by the first insulating layer 108. Of the second gate electrode array 103 electrode fingers 110, 111 are shown partly. The second gate electrode array 103 is delimited from the third gate electrode array 104 by the second insulating layer 109. Of the third gate electrode array 104 only electrode fingers 112, 113 are shown. In this view it is clear how the electrode fingers 110, 111, 112, 113 alternate.

A potential well 116 is created by applying sinusoidal voltages to the gate electrode arrays 102, 103, 104. A quantum dot 117 trapped in this potential well 116 can be moved through the substrate 10. The potential well 116 is moved longitudinally through the substrate 10 by driving the electrode fingers 110, 111, 112, 113 with sinusoidal voltages without changing the quantum mechanical properties of the quantum dot 117. The movement of quantum dot 117 in the direction of arrow 118 is indicated by dashed lines 119. The quantum mechanical state is indicated by the small arrow 114 of the quantum dot 117.

Voltage is applied to the gate electrode arrays 102, 103, 104 such that the electrode fingers 110, 111, 112, 113 form the movable potential well 116 in the substrate 10. By controlling the gate electrode arrays 102, 103, 104, the potential well 116 can be moved along the shuttling lane 4 through the substrate 10. The second gate electrode array 103 and the third gate electrode array 104 are provided with sinusoidal voltages.

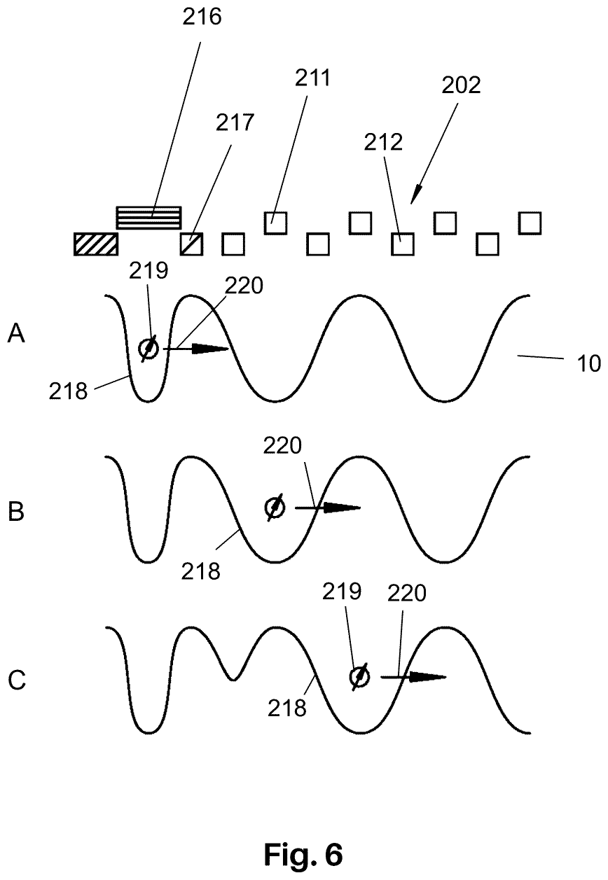

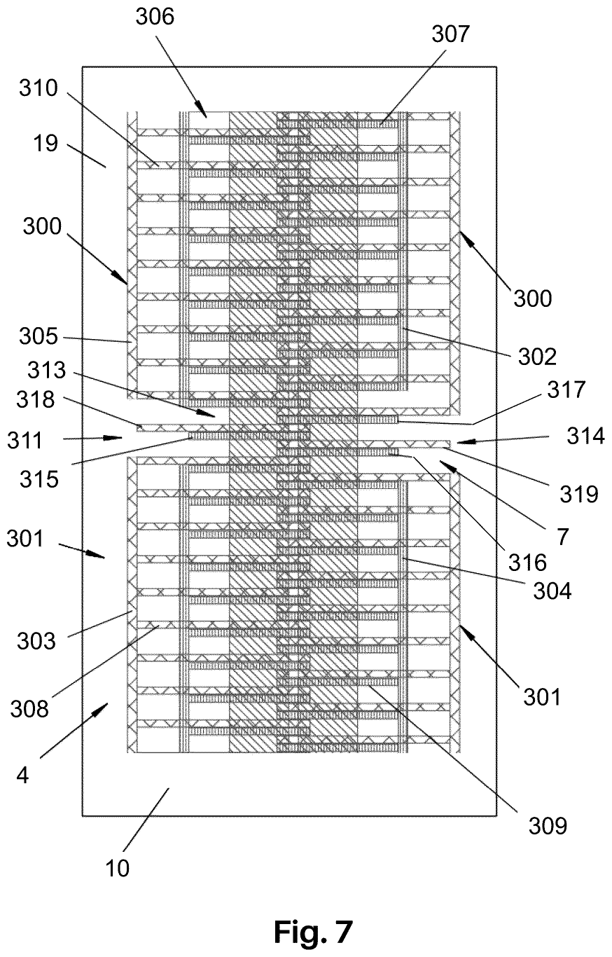

FIGS. 5 and 6 illustrate how the junctions 5 of the quantum computing element 1 of FIG. 1 can be realized. Therefore, FIG. 5 shows a part of the semiconductor substrate 10 of the quantum computing element 1 of FIG. 1. The part of the semiconductor substrate 10 shown in FIG. 5 includes one of the T-junctions 5.

The quantum computing element 1 is configured such that a two-dimensional electron gas (2DEG) is contained within the substrate 10. Gate electrode arrays 201, 202, 203 are provided on the surface 19 of the substrate 10. The gate electrode arrays 201, 202, 203 contribute to defining the shuttling lanes 4 in that the gate electrode arrays 201, 202, 203 manipulate the electrical potential within the substrate 10 such that electrons of the 2DEG can be moved in a controlled manner.

The gate electrode arrays 201, 202, 203 each comprise two respective gate electrodes 204, 205, 206, 207. The individual gate electrodes 204, 205, 206, 207 are electrically separated from each other by insulating layers 208. For this purpose, the gate electrode arrays 201, 202, 203 are constructed in layers, with the insulating layers 208 being provided between the gate electrodes 204, 205, 206, 207. The gate electrodes 204, 205, 206, 207 further comprise electrode fingers 209, 210, 211, 212. The electrode fingers 209, 210, 211, 212 of a certain gate electrode 204, 205, 206, 207 are arranged parallel to each other on the surface 19 of the substrate 10.

The gate electrode arrays 201, 202, 203 can be supplied with an electrical voltage via electrical connections (not shown in detail). By applying sinusoidal voltages to the gate electrodes 204, 205, 206, 207 of the gate electrode arrays 201, 202, a potential well can be generated within the substrate 10. A quantum dot trapped in this potential well can thus be moved through the substrate 10. The potential well can be moved longitudinally through the substrate 10 by applying sinusoidal voltages to the electrode fingers 209, 210, 211, 212.

Within the quantum dot a single electron can be trapped. If the quantum dot is moved, the electron will be moved along therewith. The spin of this trapped electron can be used as a spin qubit 9. To this end it is possible to shuttle qubits 9 through the shuttling lanes 4 with the junction 5. Therein, the electron is moved together with the quantum dot in which it is trapped. This process is continuous in that the electron remains within the same quantum dot throughout its journey passing the junction 5. The electron does not have to tunnel into a different quantum dot in order to change direction at the junction 5.

The gate electrode array 202 branches off from the gate electrode array 201 in a crossing region 213. The gate electrode arrangement 203 is disposed in the crossing region 213. The gate electrode array 203 includes two barrier gate electrodes 214, 215. The barrier gate electrodes 214, 215 can be switched on when the moving potential well with the quantum dot is located in the crossing region 213. By switching on the barrier gate electrodes 214, 215, the potential well with the quantum dot is held in the crossing region 213. A pump gate electrode 216 of the gate electrode array 203 can cause the potential well with the quantum dot to change direction towards the gate electrode array 202.

Provided that no change of direction is to be made by the potential well with the quantum dot, a barrier gate electrode 217 of the gate electrode array 203 is activated. The other two barrier gate electrodes 214, 215 are switched off. The barrier gate electrode 217 thus blocks access to the gate electrode array 202. The quantum dot in the moving potential well thus has no reason to change direction. To this end a T-junction 5 is realized through which a qubit 9 can be moved. Depending on the applied voltages, it can be decided through which branch of the junction 5 the qubit 9 leaves the junction 5.

FIG. 6 shows a cross-section through the part of the semiconductor substrate 10 of FIG. 5. For reasons of clarity, only the electrode fingers 211, 212, the barrier gate electrode 217 and the pump gate electrodes 216 are shown. Underneath, a sequence A to C is shown that illustrates a movement of a potential well 218 with a quantum dot 219.

The electrode fingers 211, 212 of the gate electrode array 202 form the moving potential well 218. The movement of the potential well 218 is effected by interconnecting the electrode fingers 211, 212. For this purpose, the electrode fingers 211, 212 of the gate electrode array 201 are periodically interconnected in an alternating manner, which causes a nearly continuous movement of the potential well 218 through the substrate 10. In FIG. 6 it is illustrated how the potential well 218 with the quantum dot 219 is branched off from the intersection region 213. The moving potential well 218 is located in the direction of the gate electrode array 202. The arrow 220 indicates the direction of movement of the potential well 218 with the quantum dot 219.

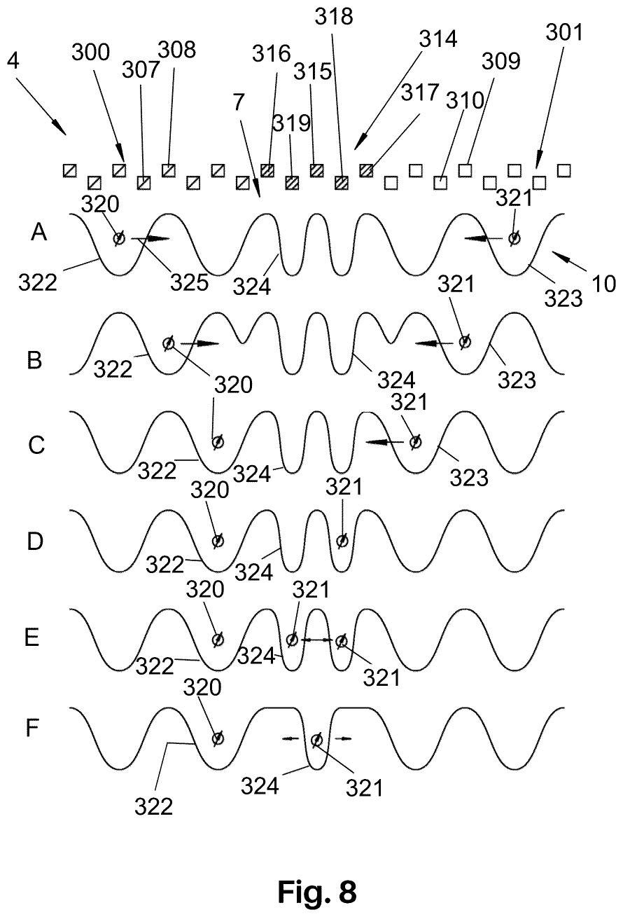

In FIG. 7 a manipulation zone 7 of the quantum computing element 1 of FIG. 1 is shown. Gate electrode arrays 300, 301, 314 are provided on a surface 19 of the substrate 10. The gate electrode arrays 300, 301 each include two gate electrodes 302, 303, 304, 305. The individual gate electrodes 302, 303, 304, 305 are electrically separated from each other by insulating layers 306. The gate electrode arrays 300, 301 are provided in layers, wherein an insulating layer 306 is provided between each gate electrode 302, 303, 304, 305 of the gate electrode arrays 300, 301. The gate electrodes 302, 303, 304, 305 further comprise electrode fingers 307, 308, 309, 310 arranged parallel to each other on the surface 19 of the substrate 10.

The manipulation zone 7 is formed in an area 311 where the gate electrode arrays 300, 301 abut each other. A manipulator 313, which includes the gate electrode array 314, is located in the manipulation zone 7. The gate electrode array 314 includes barrier gate electrodes 315, 316, 317 which form at least one static potential well. The gate electrode array 314 further includes pump gate electrodes 318, 319, each of which can cause a quantum dot or a charge carrier to move or oscillate.

An electrical voltage is applied to the gate electrode arrays 300, 301, 314 via electrical connections. By applying sinusoidal voltages to the gate electrodes 302, 303, 304, 305 of the gate electrode arrays 300, 301, a potential well is created in the substrate 10. A quantum dot or charge carrier trapped in this potential well can be moved through the substrate 10. The potential well is moved longitudinally through the substrate 10 by appropriately driving the electrode fingers 307, 308, 309, 310 with sinusoidal voltages.

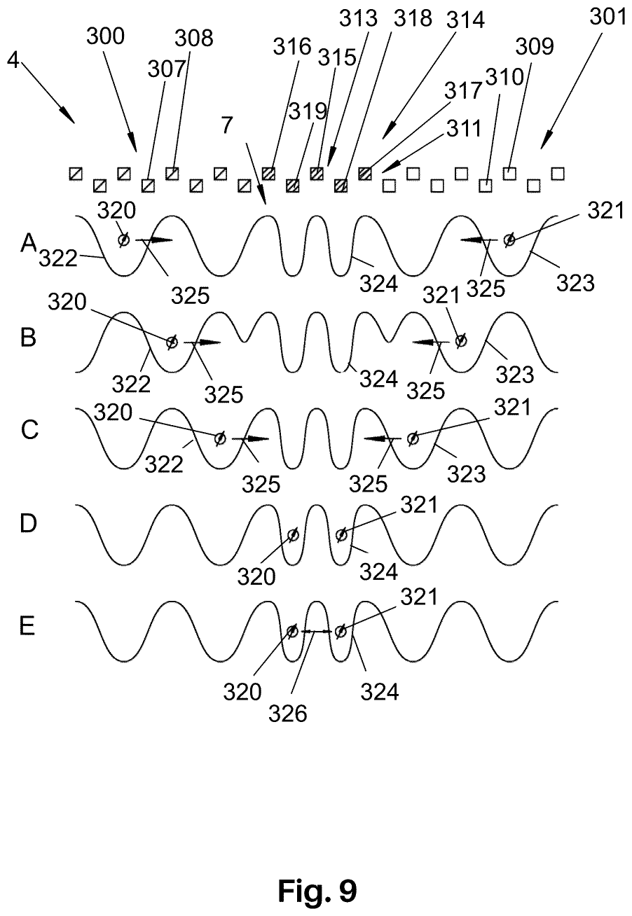

FIG. 8 illustrates the sequence of a manipulation of a charge carrier in a quantum dot 320, 321 in the manipulation zone 7 for a single-qubit operation. Therefore, a sectional view of the manipulation zone 7 is shown, wherein only the electrode fingers 307, 308, 309, 310, the barrier gate electrodes 315, 316, 317 and the pump gate electrodes 318, 319 are shown. Underneath, there is a sequences A to F of the propagation of potential wells 322, 323 in the substrate 10. Although a single-qubit operation is illustrated by FIG. 8, two quantum dots 320, 321 are shown that are trapped in the quantum wells 322, 323. The single-qubit operation is performed within the manipulation zone 7 using the quantum dot 321, while the other quantum dot 320 “waits” outside the manipulation zone 7. This can be useful in that subsequently to the single-qubit operation a two-qubit operation can be performed that involves both quantum dots 320, 321.

The electrode fingers 307, 30, 32 34 of the gate electrode arrays 300, 301 form the potential wells 322 and 323. The movement of the potential wells 322, 323 is effected by interconnecting the electrode fingers 307, 308, 309, 310 appropriately. For this purpose, the electrode fingers 307, 308, 309, 310 of the gate electrode arrays 300, 301 are periodically interconnected in an alternating manner, which cause a nearly continuous movement of the potential wells 322, 323 through the substrate 10.

A static double well 324 is formed in the manipulation zone 7. The static double well 324 is created by the barrier gate electrodes 315, 316, 317. First, the quantum dot 321 is brought in with the movable potential well 323 to the static double potential well 324 in the manipulation zone 7. This is indicated by a horizontal arrow 325. The manipulator 313, for example a gradient magnetic field, allows the quantum dot 321 to assume a defined quantum mechanical state. The other quantum dot 320 waits outside the manipulation zone 7. By moving in the magnetic field gradient of the manipulator 313, a defined quantum state of the quantum dot 321 is achieved. It is now possible for the quantum dot 321 to assume a defined quantum state by delocalizing in the double well (E) or by moving rapidly back and forth in the magnetic field gradient (F). When guided away from the manipulation zone 7, the quantum dot 321 thus has a defined quantum mechanical state.

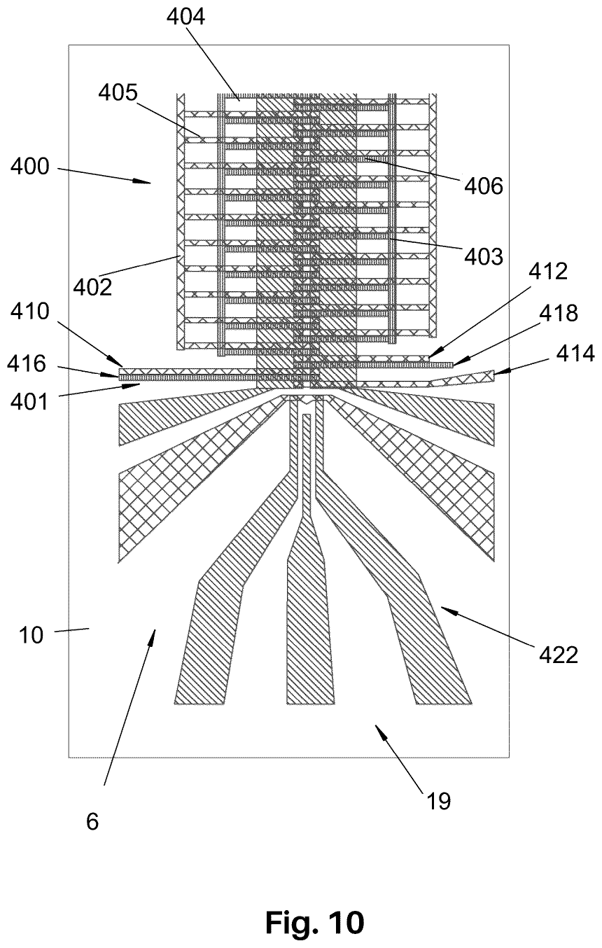

FIG. 9 illustrates the sequence of a manipulation in the manipulation zone 7 of a two-qubit operation. Therein, a static double well 324 is formed in the manipulation zone 7 by the barrier gate electrodes 315, 316, 317. Quantum dots 320, 321 are moved to the static double potential well 324 in the manipulation zone 7 by the movable potential wells 322, 323 and each is introduced into the double potential well 324. The manipulator 313, for example a gradient magnetic field, allows the quantum dots 320, 321 to assume a defined quantum mechanical state. Two-qubit operations can be performed between the quantum dots 320, 321 by exchange interaction, which is indicated by a horizontal double arrow 326. Thus, the quantum dots 320, 321 moved away from the manipulation zone 312 acquire defined quantum mechanical states.

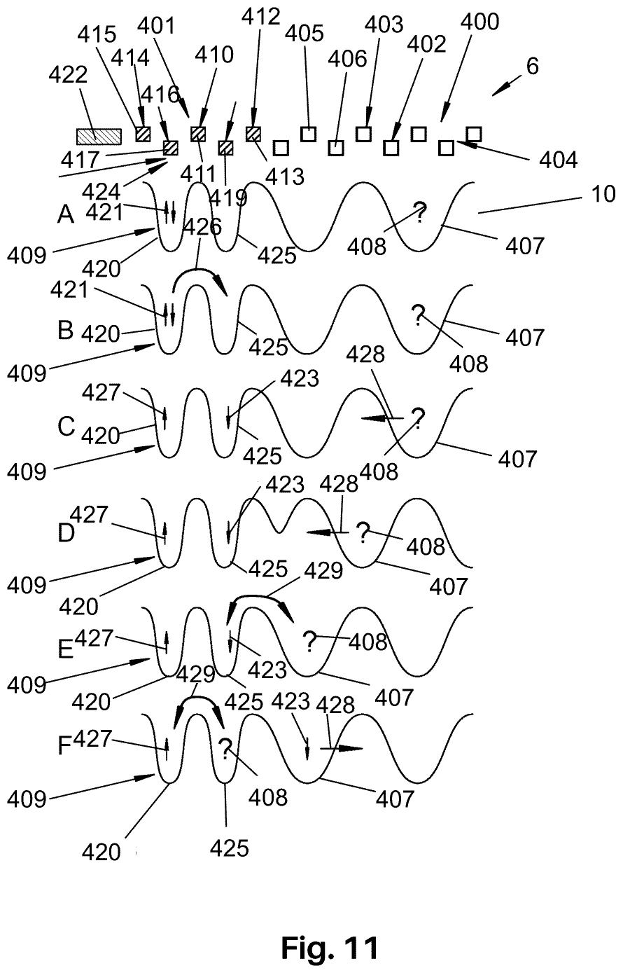

In FIG. 10 a loading terminal 6 of the quantum computing element 1 of FIG. 1 is shown. Gate electrode arrays 400, 401 are provided on the surface 19 of the substrate 10. The gate electrode array 400 has two gate electrodes 402, 403. The individual gate electrodes 402, 403 are electrically separated from each other by insulating layers 404. The gate electrodes 402, 403 of the gate electrode array 400 are provided in layers for this purpose, with the insulating layer 404 being provided between each gate electrode 402, 403 of the gate electrode array 400. The gate electrodes 402, 403 further comprise electrode fingers 405, 406 arranged parallel to each other on the surface 19 of the substrate 10.

Voltage is applied to the gate electrode arrays 400, 401 via electrical connections. By applying sinusoidal voltages to the gate electrodes 402, 403 of the gate electrode array 400, a movable potential well is created in the substrate 10. A quantum dot 408 or charge carrier trapped in this potential well can thus be moved through the substrate 10. The potential well is moved longitudinally through the substrate 10 by driving the electrode fingers 405, 406 of the gate electrodes 402, 403 with sinusoidal voltages.

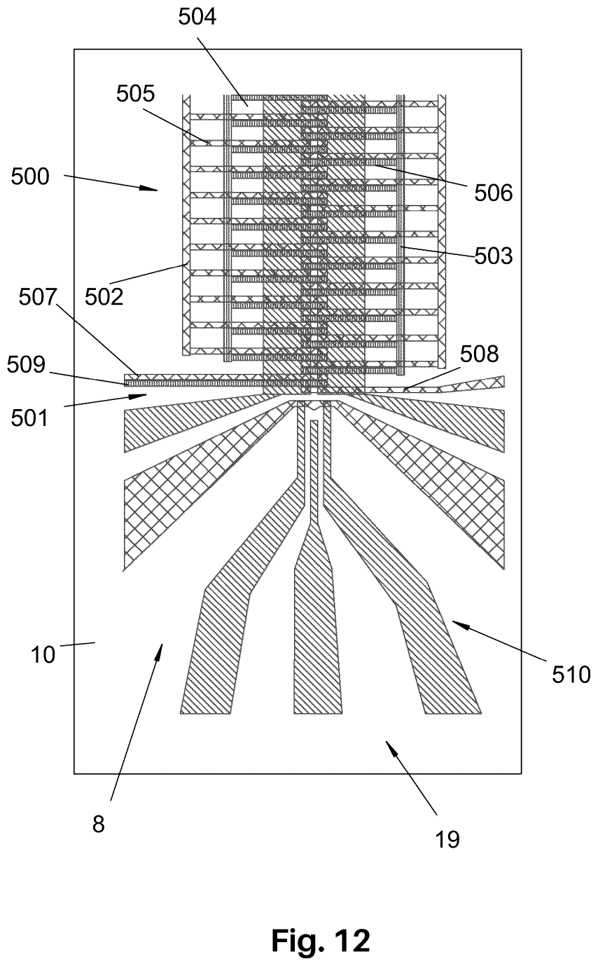

The gate electrode array 401 forms a static double potential well. For this purpose, the gate electrode array 401 comprises barrier gate electrodes 410, 412, 414, a pump gate electrode 416 and a further pump gate electrode 418 which can set a quantum dot or a charge carrier in motion or oscillation. The pump gate electrodes 416, 418 are arranged alternately between the barrier gate electrodes 410, 412 and 414. The gate electrodes 410, 412, 414, 416, 418 each have electrode fingers 411, 413, 415, 417, 419 (which are labelled with reference signs in FIG. 11). Connected to the barrier gate electrode 410, 412, 414 of gate electrode array 401 is a reservoir 422 for introducing charge changes.

FIG. 11 illustrates the sequence A to F of loading a charge carrier. The electrode fingers 405, 406 of the gate electrode array 400 form potential wells 407 that are movable through the substrate 10. The movement of the potential wells 407 is thereby effected by a suitable interconnection of the electrode fingers 405, 406. For this purpose, the electrode fingers 405, 406 of the gate electrode array 400 are periodically interconnected in an alternating manner, which cause a nearly continuous movement of the potential well 407 through the substrate 10.

The loading terminal 6 is based on the Pauli principle, according to which an electronic level can never be occupied by electrons of the same spin. By means of the gate electrodes 410, 412, 414 and 416, 418, a static double potential well 409 is generated on the one hand and the movable potential well 407 is generated on the other hand by means of the gate electrodes 402, 403. Two charge carriers 421 from the reservoir 422 are introduced into a first potential well 420 of the static double potential well 409. The charge carriers 421 are split and aligned with a stimulator 424, for example using a gradient magnetic field and the pump gate electrodes 416, 418. A split-off charge carrier 423 tunnels into a second static potential well 425 of the double potential well 409, which is indicated by arrow 426. Only one charge carrier 427 remains in the first static potential well 420. The quantum states of the quantum dots 423, 427 in the potential wells 420, 421 are known by the orientation of an applied gradient magnetic field.

By means of the movable potential well 407, another quantum dot 408 is brought to the second static potential well 425 of the double potential well 409 in the same level. The quantum mechanical state of the quantum dot 408 is not known. Arrow 428 indicates the translation direction of quantum dot 408 with moving potential well 407. By tunneling effect, the quantum dot 423 of the second static potential well 425 exchanges with the quantum dot 408 of the moving potential well 407. The known quantum mechanical state of the quantum dot 423 is now in the moving potential well 407 and initializes, for example, a qubit.

The quantum dot 408 tunnels, if it has the same spin as the quantum dot 423 now moved away to initialize, back into the first static potential well 420 of the double potential well 409. Thus, a sensor element not shown here would not detect any change in charge. If the quantum mechanical states of the quantum dot 423 and 408 are different, a charge change could be detected. The exchange by tunneling is symbolized by arrow 429.

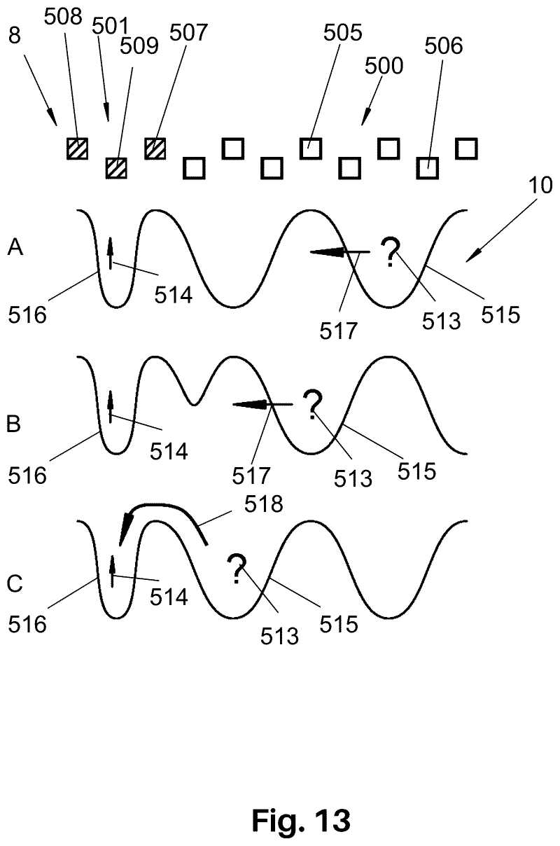

In FIG. 12 a readout terminal 8 of the quantum computing element 1 of FIG. 1 is shown. Therein, gate electrode arrays 500, 501 are shown that each includes two gate electrodes 502, 503. The individual gate electrodes 502, 503 are electrically separated from each other by insulating layers 504. The gate electrode arrays 500, 501 are provided in layers for this purpose, with the insulating layer 504 being provided between each gate electrode 502, 503. The gate electrodes 502, 503 further comprise electrode fingers 505, 506 arranged parallel to each other on the surface 19 of the substrate 10.

Suitable voltage is applied to the gate electrode arrays 500, 501 via electrical connections. By applying sinusoidal voltages to the gate electrodes 502, 503 of the gate electrode array 500, a potential well is created in the substrate 10. A quantum dot or charge carrier trapped in this potential well can thus be moved through the substrate 10. The potential well is moved longitudinally through the substrate 10 by driving the electrode fingers 505, 506 with sinusoidal voltages.

The gate electrode array 500 forms a region in which a quantum dot can be moved by means of a potential well. In contrast, the gate electrode array 501 forms a static potential well. For this purpose, the gate electrode array 501 comprises barrier gate electrodes 507, 508 and a pump gate electrode 509 which can set a quantum dot or a charge carrier in motion or oscillation. The pump gate electrode 509 is arranged between the barrier gate electrodes 507, 508. The gate electrodes 507, 508 and 509 are also each separated by an insulating layer 504.

Connected to the barrier gate electrode array 501 is a sensor element 510 for detecting changes in charge. The sensor element 510 detects the charge present in the static potential well. The potential well is generated by the gate electrode array 501.

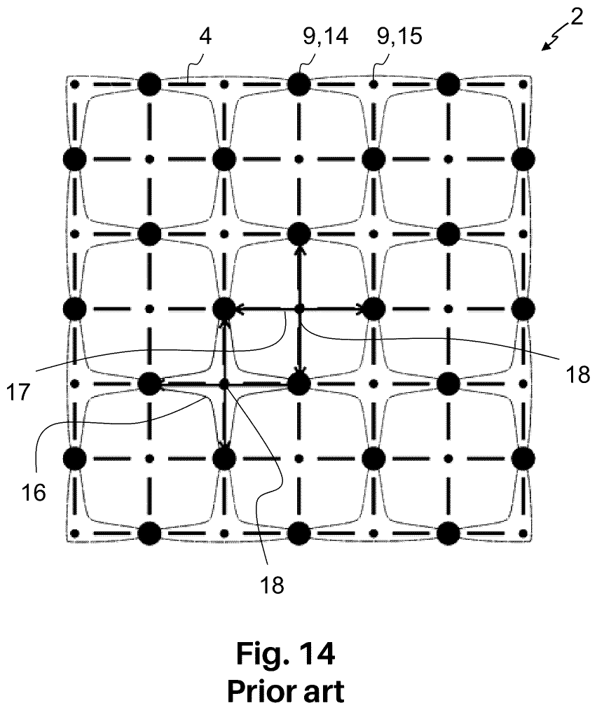

FIG. 13 illustrates the sequence for a readout of a quantum state of a qubit in a quantum dot 513. The figure shows the readout terminal 8 in a simplified manner so that only the electrode fingers 505, 506, the barrier gate electrodes 507, 508 and the pump gate electrodes 509 are visible. Underneath, sequences from A to C of the courses of potential wells 515, 516 are shown. The electrode fingers 505, 506 of the gate electrode array 500 form the moving potential well 515. The movement of the quantum dot 513 in the potential well 515 is thereby effected by the suitable interconnection of the electrode fingers 505, 506. For this purpose, the electrode fingers 505, 506 of the gate electrode array 500 are periodically interconnected in an alternating manner, which cause a nearly continuous movement of the quantum dot 513 in the potential well 515 through the substrate 10.

The readout terminal is based on the Pauli principle. By means of the gate electrodes 507, 508, on the one hand, the static potential well 516 is generated and, on the other hand, the movable potential well 515 is generated by means of the gate electrodes 505, 506. A quantum dot 513, of which the quantum mechanical state at a level—in the case of an electron, the spin—is known, is introduced into the static potential well 516. The quantum dot 513 is aligned with the pump gate electrode 508, e.g., spin-up, as shown here. By means of the movable potential well 515, another quantum dot 514 is brought up to the static potential well 516 at the same level. Arrow 517 indicates the direction of the movement of the quantum dot 514 with movable potential well 515. If the quantum mechanical states are different, the level is now filled. The filling up can be done by tunneling, which is symbolized by arrow 518.

The sensor element 510 detects a changed charge on this level in the case that a quantum dot has been added. If the quantum mechanical states of the quantum dots 513, 514 are the same, then the level cannot accept another charge carrier. Thus, the quantum mechanical state does not change at this level. Thus, it can be determined which quantum mechanical state the approached quantum dot 513 has.

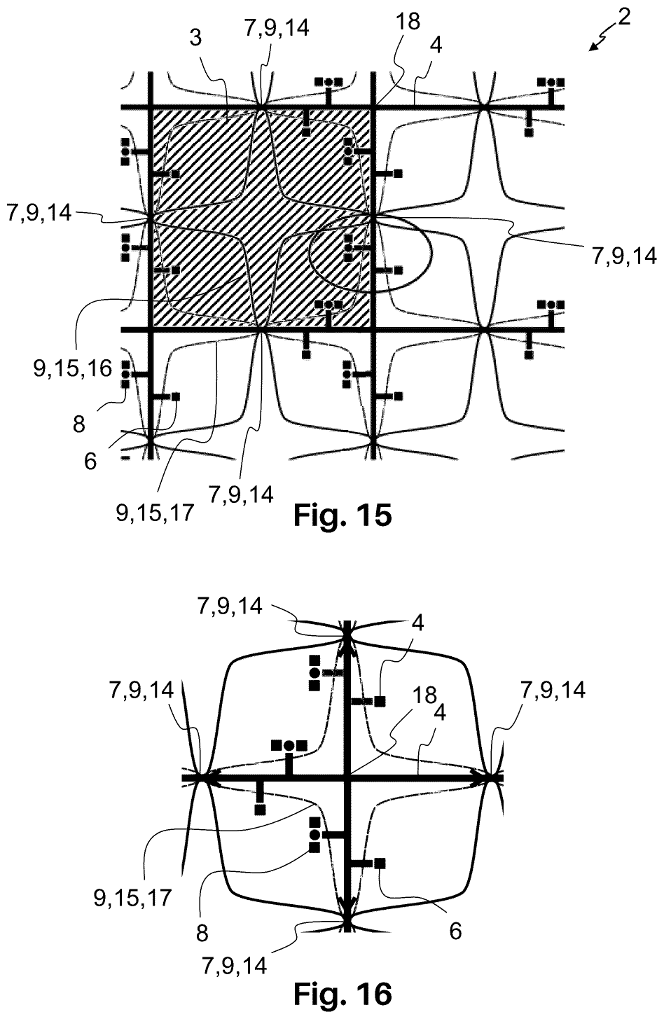

FIG. 14 illustrates the prior art described in Fowler et al. Therein, a network 2 of shuttling lanes 4 is used. Within the network, a plurality of qubits 9 is shown, which can either be data qubits 14 or an ancillary qubits 15. The data qubits 14 are stationary, whereas the ancillary qubits 15 are shuttled between the neighboring data qubits 14. Half the ancillary qubits 15 are used for so-called X-stabilizers 16, of which one is labelled with a reference sign. The remaining ancillary qubits 15 are used for so-called Z-stabilizers 17, of which one is labelled with a reference sign. That is, each of the ancillary qubits 15 is either used for an X-stabilizer 16 or for a Z-stabilizer 17. Both the X-stabilizers 16 and the Z-stabilizers 17 are performed such that the respective ancillary qubit 15 is shuttled across an X-junction 18. Whenever an ancillary qubit 15 is shuttled to a data qubit 14, a two-qubit operation in a manipulation zone is performed. The X-stabilizers 16 and the Z-stabilizers 17 are performed alternatingly.

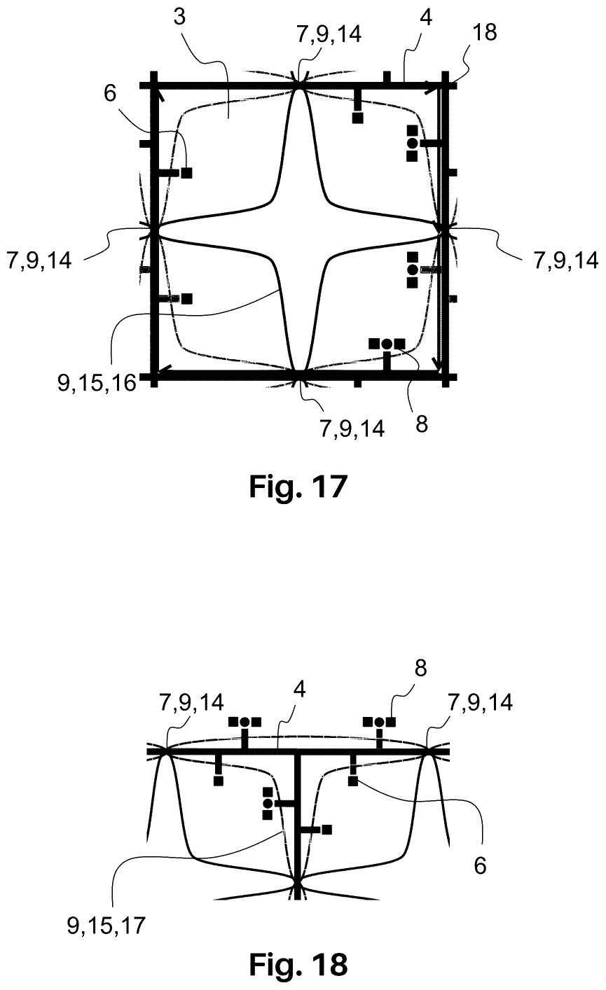

FIG. 15 illustrates the method for error correction according to the invention in comparison to FIG. 14. FIG. 15 shows a network 2 of shuttling lanes 4 that form network cells 3. The network cells 3 are defined such that the shuttling lanes 4 constitute the edges of the network cells 3. Exemplarily, one of the network cells 3 is highlighted by a hatching. The network 2 comprises X-junctions 18. For practical reasons, an X-junction 18 is preferably realized by a pair of T-junctions. However, for reasons of clarity this detail is not shown in FIG. 15. Along the edges of the network cells 3 there are manipulation zones 7. Each of the manipulation zones 7 hosts a respective data qubit 14. The data qubits 14 are stationary. Also, there are loading terminals 6 and readout terminals 8. The network 3 also hosts ancillary qubits 15 that, however, are not bond to any of the network cells 3. Thus, the location of the ancillary qubits 15 is indicated in FIG. 15 only schematically in that X-stabilizers 16 and Z-stabilizers 17 are shown that can be performed using the ancillary qubits 15. To this end it should be noted that one ancillary qubit 15 can be used to perform an X-stabilizer 16 and, subsequently, a Z-stabilizer 17. The terms “X-stabilizer” and “Z-stabilizer” are used merely to facilitate the comparison with the prior art teaching of FIG. 14. In fact, in particular the way the X-stabilizers 16 of FIG. 15 are performed constitutes a key difference from the teaching of FIG. 14. Both the data qubits 14 and the ancillary qubits 15 are qubits 9.

FIG. 16 illustrates a Z-stabilizer 17. Similar in the prior art method of FIG. 14, the Z-stabilizers 17 are performed by shuttling the ancillary qubits 15 across a respective X-junction 18. The ancillary qubits 15 are therefore moved along paths having an X-shape. The Z-stabilizers 17 are performed in that the method for error correction comprises for at least some of the X-junctions 18 of the network 2:
A1) initializing a respective ancillary qubit 15 in one of the shuttling lanes 4 adjacent to the respective X-junction 18,
A2) successively shuttling the ancillary qubit 15 to the manipulation zones 7 adjacent to the respective X-junction 18 and entangling the ancillary qubit 15 with the data qubits 14 in these manipulation zones 7,
A3) reading out the ancillary qubit 15.

In step A1) the ancillary qubit 15 can be initialized anywhere between the shown X-junction 18 and one of the four neighboring manipulation zones 7, where the data qubits 14 are hosted. The initialization can be performed, for example, using any of the loading terminals 6. In step A2) the ancillary qubit 15 is shuttled to each of these four manipulation zones 7 as indicated by arrows. In step A3) the ancillary qubit 15 is read out, for example using any of the readout terminals 8.

FIG. 17 illustrates an X-stabilizer 16. However, the X-stabilizer 16 differs from the X-stabilizers 16 according to the prior art method of FIG. 14. Here, the X-stabilizers 16 are performed by shuttling the ancillary qubits 15 along the edges of the network cell 3. The ancillary qubits 15 are therefore moved along rectangular paths. This is possible because there is no strict assignment between ancillary qubits 15 and network cells 3.

The X-stabilizers 16 are performed in that the method for error correction comprises for each of the network cells 3:
B1) initializing a respective ancillary qubit 15 in one of the shuttling lanes 4 of the respective network cell 3,
B2) successively shuttling the ancillary qubit 15 to the manipulation zones 7 of the respective network cell 3 and entangling the ancillary qubit 15 with the data qubits 14 in these manipulation zones 7,
B3) reading out the ancillary qubit 15.

In step B1) the ancillary qubit 15 can be initialized anywhere along the shuttling lanes 4 shown in FIG. 17. The initialization can be performed, for example, using any of the loading terminals 6. Alternatively, the initialization according to step B1) can be achieved by the reading out according to step A3). To this end, steps A3) and B1) can be performed jointly. In step B2) the ancillary qubit 15 is shuttled to each of these four manipulation zones 7 as indicated by arrows. To this end it should be noted that the ancillary qubit 15 can be shuttled “past” the data qubit 14 by using SWAP gates. Therein, it is possible that the charge carrier used for realizing the data qubit 14 before the swap is used for realizing the ancillary qubit 15 after the swap, and vice versa. This is possible because the qubit, i.e. the representation of a certain quantum state, is supposed to be moved, which is not strictly bond to a certain charge carrier. In step B3) the ancillary qubit 15 is read out, for example using any of the readout terminals 8.

Preferably, steps A1) to A3) are performed alternatingly with steps B1) to B3). It is also preferred that steps A1) to A3) are performed simultaneously for all ancillary qubits 15 and that steps B1) to B3) are performed simultaneously for all ancillary qubits 15. To this end the ancillary qubits 15 can be used alternatingly for performing a respective Z-stabilizer 17 and a respective X-stabilizer 16.

FIG. 18 illustrates an ancillary qubit 15 at an edge of the network 2 of the shuttling lanes 4. This ancillary qubit 15 is used for performing a Z-stabilizer 17 only.

### LIST OF REFERENCE NUMERALS

1 quantum computing element
2 network
3 network cell
4 shuttling lane
5 junction
6 loading terminal
7 manipulation zone
8 readout terminal
9 spin qubit
10 substrate
11 quantum computer
12 control installation
14 data qubit
15 ancillary qubit
16 X-stabilizer
17 Z-stabilizer
18 X-junction
19 surface
100 first side
101 second side
102 first gate electrode array
103 second gate electrode array
104 third gate electrode array
105 electrical terminal
106 electrical terminal
107 electrical terminal
108 first isolation layer
109 second isolation layer
110 electrode finger (second layer)
111 electrode finger (second layer)
112 electrode finger (third layer)
113 electrode finger (third layer)
114 arrow
115 gate electrodes (first layer)
116 potential well
117 quantum dot
118 direction of arrow
119 dashed line
201 gate electrode array
202 gate electrode array
203 gate electrode array
204 gate electrodes
205 gate electrodes
206 gate electrodes
207 gate electrodes
208 insulating layers
209 electrode fingers
210 electrode fingers
211 electrode fingers
212 electrode finger
213 crossing region
214 barrier gate electrode
215 barrier gate electrode
216 pump gate electrode
217 barrier gate electrode
218 moving potential well
219 quantum dot
220 arrow
300 gate electrode array
301 gate electrode array
302 gate electrode
303 gate electrode
304 gate electrode
305 gate electrode
306 insulating layer
307 electrode finger
308 electrode finger
309 electrode finger
310 electrode finger
311 area
313 manipulator
314 gate electrode array
315 barrier gate electrodes
316 barrier gate electrodes
317 barrier gate electrodes
318 pump gate electrodes
319 pump gate electrodes
320 quantum dot
321 quantum dot
322 moving potential well
323 moving potential well
324 static double well
325 horizontal arrow
326 horizontal double arrow
400 gate electrode array
401 gate electrode array
402 gate electrode
403 gate electrode
404 insulating layers
405 electrode finger
406 electrode finger
407 potential well
408 quantum dot
409 static double potential well
410 barrier gate electrode
411 electrode finger
412 barrier gate electrode
413 electrode finger
414 barrier gate electrode
415 electrode finger
416 pump gate electrode
417 electrode finger
418 pump gate electrode
419 electrode finger
420 1st static potential well
421 charge carrier
422 reservoir
423 split-off quantum dot
424 stimulator
425 2nd static potential well
426 arrow (tunneling)
427 remaining quantum dot
428 arrow (translation)
429 arrow (exchange interaction)
500 gate electrode array
501 gate electrode array
502 gate electrodes
503 gate electrodes
504 insulating layer
505 electrode finger
506 electrode finger
507 barrier gate electrode
508 barrier gate electrode
508 pump gate electrode
510 sensor element
513 quantum dot
514 quantum dot
515 moving potential well
516 static potential well
517 arrow (translation)
518 arrow (tunneling)

1. A method for operating a quantum computing element with a network of shuttling lanes having multiple junctions and multiple manipulation zones, wherein the method respectively comprises for a plurality of spin qubits:
a) initializing the qubit;
b) manipulating the qubit in at least one of the manipulation zones; and
c) reading out the qubit;
wherein at least one of the qubits is shuttled along the network of the shuttling lanes between steps a) and c) so as to pass at least four different of the junctions.

2. The method according to claim 1, wherein steps a) to c) are performed simultaneously for at least some of the qubits.

3. The method according to claim 1, wherein the method comprises multiple adjacent time intervals, and wherein in each of the time intervals steps a) to c) are performed for a respective set of the qubits.

4. The method according to claim 1, wherein at least temporarily the number of qubits is higher than half the number of the junctions.

5. The method according to claim 1, wherein at least some of the qubits are shuttled past the at least one manipulation zone in which they are manipulated in step b).

6. The method according to claim 1, wherein at least some of the qubits have a shuttling direction reversed at the at least one manipulation zone in which they are manipulated in step b).

7. The method according to claim 1, wherein at least some of the qubits are successively manipulated in multiple of the manipulation zones, and wherein the respective qubits are shuttled in between these manipulation zones.

8. The method according to claim 1, wherein for at least some of the qubits the manipulation in the respective step b) is an entanglement with at least one further of the qubits.

9. The method according to claim 1, wherein the method is a realization of a surface code.

10. A quantum computer comprising:
a quantum computing element having a network of shuttling lanes with multiple junctions and multiple manipulation zones; and
a control installation connected to the quantum computing element and configured for performing a method according to any of the preceding claims.

11. A method for error correction using a quantum computing element with a network of shuttling lanes having multiple X-junctions so as to form multiple network cells, wherein the network further has multiple manipulation zones, wherein the method comprises initializing a respective data qubit in each of the manipulation zones, wherein the method comprises for at least some of the X-junctions of the network:
A1) initializing a respective ancillary qubit in one of the shuttling lanes adjacent to the respective X-junction;
A2) successively shuttling the ancillary qubit to the manipulation zones adjacent to the respective X-junction and entangling the ancillary qubit with the data qubits in these manipulation zones; and
A3) reading out the ancillary qubit;
wherein the method subsequently comprises for each of the network cells:
B1) initializing a respective ancillary qubit in one of the shuttling lanes of the respective network cell;
B2) successively shuttling the ancillary qubit to the manipulation zones of the respective network cell and entangling the ancillary qubit with the data qubits in these manipulation zones; and
B3) reading out the ancillary qubit;
wherein the data qubits and the ancillary qubits are spin qubits.

12. The method according to claim 11, wherein steps A1) to A3) are performed alternatingly with steps B1) to B3).

13. The method according to claim 11, wherein steps A1) to A3) are performed simultaneously for all ancillary qubits and/or wherein steps B1) to B3) are performed simultaneously for all ancillary qubits.
